(19) United States
(12) Patent Application Publication
(10) Pub. No.: US 2005/0029061 A1
(43) Pub. Date: Feb. 10, 2005

(54) Parking brake

(75) Inventors: Markus Bohm, Remscheid (DE); Ulf Braker, Berlin (DE); Michael Lorenz, Scharding (AT); Jurgen Balz, Hunstetten (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Edscha Betaetigungssysteme GmbH

(21) Appl. No.: 10/432,502

(22) PCT Filed: Nov. 21, 2001
(86) PCT No.: PCT/DE01/04330

(30) Foreign Application Priority Data
Nov. 21, 2000 (DE) 100 57 909.4
May 15, 2001 (DE) 101 23 525.9

(51) Int. Cl. F16D 69/00

(52) U.S. Cl. 188/265

(57) ABSTRACT

The invention relates to a parking brake for a vehicle, comprising a handle (2) which can be displaced in relation to a mounting (6), a coupling unit (3), which tenses a brake cable (4) when the handle (2) is displaced, and a fixing device (17) for fixing the handle (2) in a fixed position. The aim of the invention is to provide a parking brake that can convert a pulling force on a handle into a tensing of the brake cable using constructionally compact, economical means. To this end, the handle (2) can be pulled axially away from the mounting (6) by a guide (5, 7), and a conversion unit (8) is connected to the mounting (6), said unit converting the axial displacement of a part that is associated with the handle (2) into a tensing of the brake cable (4).

The invention relates to a parking brake in accordance with the preamble of claim 1 for a vehicle, comprising a hand-grip which can be displaced relative to a holder, a coupling unit which tensions a brake cable during displacement of the hand-grip, and a locking device in order to hold the hand-grip in a locking position.

Parking brakes, in particular foot-operated parking brakes for motor vehicles, are known in practice which, when a brake actuation lever designed, for example, with a pedal is actuated, exert a corresponding pull on a brake cable pulling on the brake shoes of the parking brake, the latter being tensioned thereby. One disadvantage of these parking brakes is that the lever arm of the pedal, on the one hand, and the distance of the articulation of the brake cable from the articulation point, which is fixed on the bodywork, of the brake actuation lever, on the other hand, define unfavorable lever ratios (about 1 to 2), so that, in practice, tension members which bring about a step-up of about four times the pull exerted on them have to be installed between a first and a second part of the brake cable. Such tension members present problems, because, as a rule, the adjustment of the brake cable due to the wear of the brake linings is possible only on one part of the brake cable and the adjustment can therefore be compensated for only inadequately. Moreover, these parts make it difficult to install the brake cable, because the latter can be led only at a distance from these and thus make the mounting more costly. In addition, a tension member of this type always forms a weak point for material faults and mounting errors.

The object of the invention is to provide a parking brake in accordance with the preamble of claim 1 which converts a tractive force applied to a hand-grip into a tensioning of the brake cable in a compact and cost-effective manner.

This object is achieved in the case of the parking brake according to the invention mentioned at the beginning by the characterizing features of claim 1 in that the hand-grip can be pulled away axially from the holder via a guide, and in that a conversion unit is coupled to the holder and converts the axial displacement of a part assigned to the hand-grip into a tensioning of the brake cable.

The parking brake according to the invention requires little space in the region of the central console between the driver=3 s seat and front-passenger seat and thus makes possible a plurality of novel options for utilizing the gain in space, for example for a cup-holder.

The parking brake according to the invention makes it possible to couple the brake cable to a pulling movement of the hand-grip without the driver having to overcome the load on the brake cable without any changes. On the contrary, the parking brake according to the invention converts the travel of the hand-grip, which can be pulled out, to the travel of the brake cable by it being possible to pull the hand-grip out of its guide by a number of centimeters. It is possible to assist the pulling force by means of a motor or by means of springs.

The design of the parking brake according to the invention makes it possible to design that part of a hand brake which is to be provided in the passenger compartment between the front seats to be very short by, for example, only the hand-grip being visible and the further region being used by arm rests or the like.

The parking brake according to the invention affords a favorable transmission ratio by the provision of a conversion unit which converts the axial movement of the hand-grip into another axial brake-cable tensioning movement.

The conversion unit is defined, for example by a gearwheel or friction wheel transmission which is used to actuate a lever on which the coupling unit is arranged. As an alternative, multi-joint kinematics may also be provided for the same purpose which comprises a lever, on which the coupling unit is articulated, and which can be pivoted relative to the holder about a pivot joint, with a force being applied to that limb of the lever which faces away from the coupling unit via a control link. Four links are preferably series connected.

A support part is preferably provided in the region of the holder, said support part having an articulation for a cable pulley or at least one section or one segment of a cable pulley. A traction cable is guided peripherally by the cable pulley. The traction cable is coupled at one end to the cable pulley and at its other end to the hand-grip in such a manner that the traction cable is likewise pulled during displacement of the hand-grip. Since the traction cable preferably does not execute a change in length and is produced, for example, from metal, the cable pulley is pivoted about the articulation during pulling on the hand-grip.

The brake cable is coupled directly or indirectly to the cable pulley, with the distance of the articulation of the brake cable from the articulation of the cable pulley being preferably smaller than the radius around which the traction cable is wound, so as to obtain a step-up.

According to a first preferred development of the invention, the brake cable is coupled rigidly to the cable pulley. In order to bring about the smaller radius from the articulation than the radius of the cable pulley, the brake cable can be guided to a brake-cable articulation via a deflection roller, second cable pulley, a sliding element or the like.

According to a further preferred development of the invention, a link is coupled to the cable pulley, the other end of which link is supported on the support part and, in particular, can be mounted on the support part, with a limb, which protrudes from the link and is shorter than the length of the link, protruding from the support on the support part and having the articulation for the brake cable. This design gives rise to particularly favorable, in particular also progressive lever ratios during actuation of the parking brake.

According to yet another preferred development of the invention, the brake cable can be pivoted via a plurality of links and levers, a plurality of links which are coupled to one another being used to pivot a coupling unit, which is coupled to one of the links and is intended for the brake cable, about an articulation at the same time as the hand-grip is displaced, with the shortening in the distance of an extension of the hand-grip, which engages on one of the links, being compensated for by an articulated connection and angling of the links which is thereby made possible.

A locking catch is expediently prestressed by a catch spring in the direction of a tooth segment, with it being possible for the pretensioning of the catch spring to be canceled by actuation of a push-button or by pulling on a pull linkage, in order to release the locking position. The catch spring is formed, for example, as a leg spring, one leg of which is arranged on the lever holder and the other leg of which is arranged on the lever arm of the locking catch, which lever arm faces the toothing and has an engagement lug.

The parking brake according to the invention permits the achievement, in a compact manner, of a step-up of the brake actuation lever relative to the brake cable by a factor of between two and eleven, preferably of between four and ten. It has to be understood that, as before, brake-boosting members may be provided in the region of the brake cable, but this is advantageously no longer required. In particular, a step-up can be set which has an extent suitable for motor-vehicle parking brakes and manages without brake converters. The magnitude of the step-up results from the expedient selection of the distance of the joints of the lever from one another.

The coupling unit preferably comprises an adjusting device for the brake cable, as is disclosed, for example, in WO-A-98 57 832, said adjusting device being used, when the parking brake is set down or not actuated, to adjust the brake cable on the basis of a spring force in order, if there are large differences in temperature, but in particular due to the wear of the brake lining, to bring about a taut tensioning of the brake cable whenever the parking brake is released.

The parking brake according to the invention can be designed either as a hand-operated parking brake with a hand-grip, in which a push-button actuates the release function of the locking catch, or as a foot-operated parking brake, in which the brake actuation lever is provided with a pedal and the unlocking of the locking catch is realized via a pull mechanism.

Further advantages and features of the invention emerge from the following description and from the dependent claims.

The invention will be explained in more detail below using preferred exemplary embodiments of a parking brake according to the invention and with reference to the attached drawings.

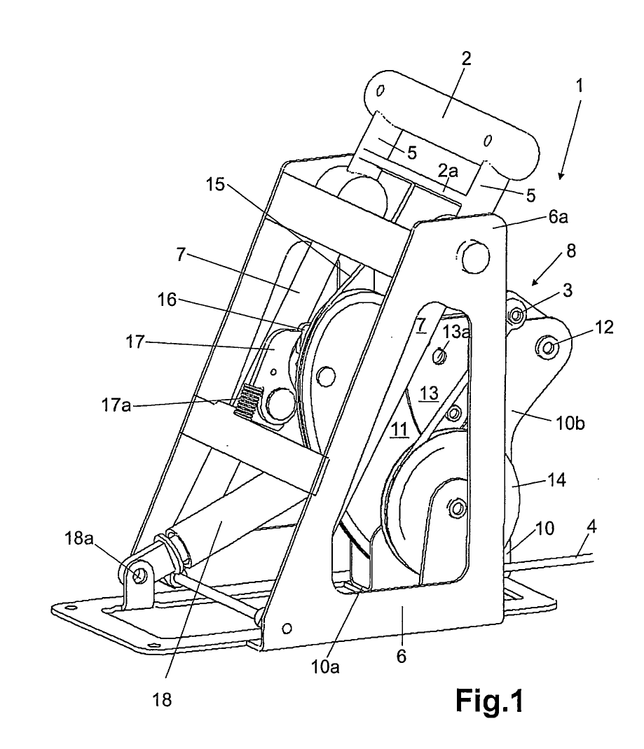

FIG. 1 shows a perspective view of a preferred embodiment of a parking brake according to the invention in an unactuated state.

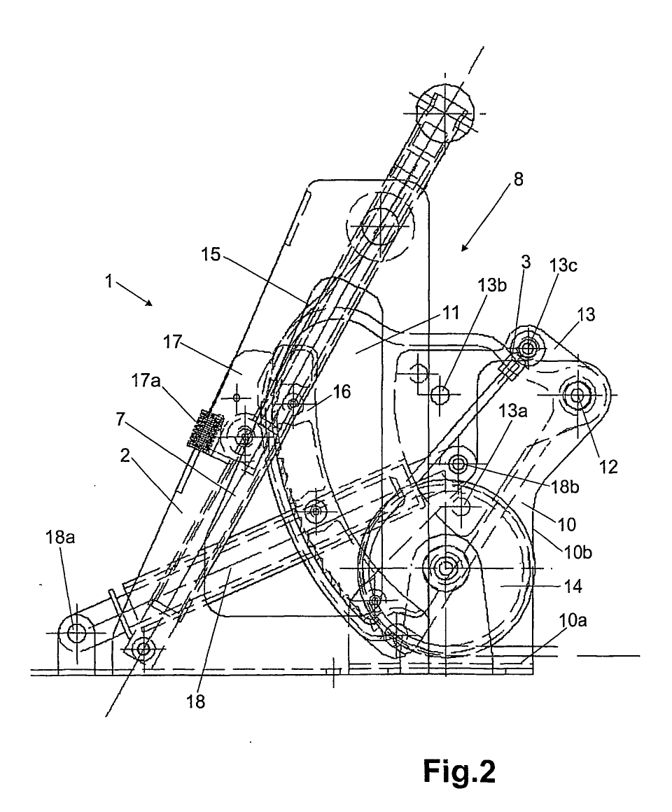

FIG. 2 shows a schematic side view of the parking brake according to FIG. 1 in an unactuated state.

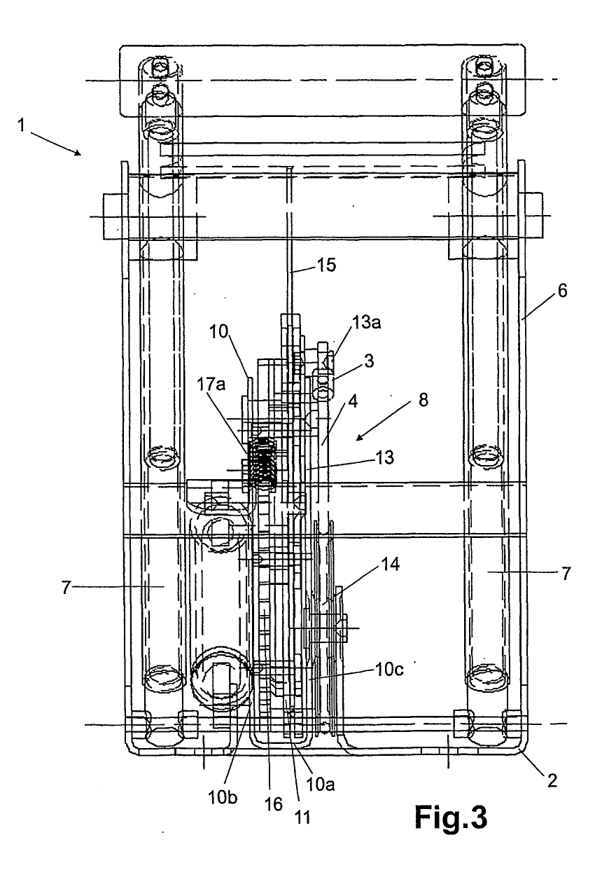

FIG. 3 shows a plan view from above of the parking brake according to FIG. 1 and 2.

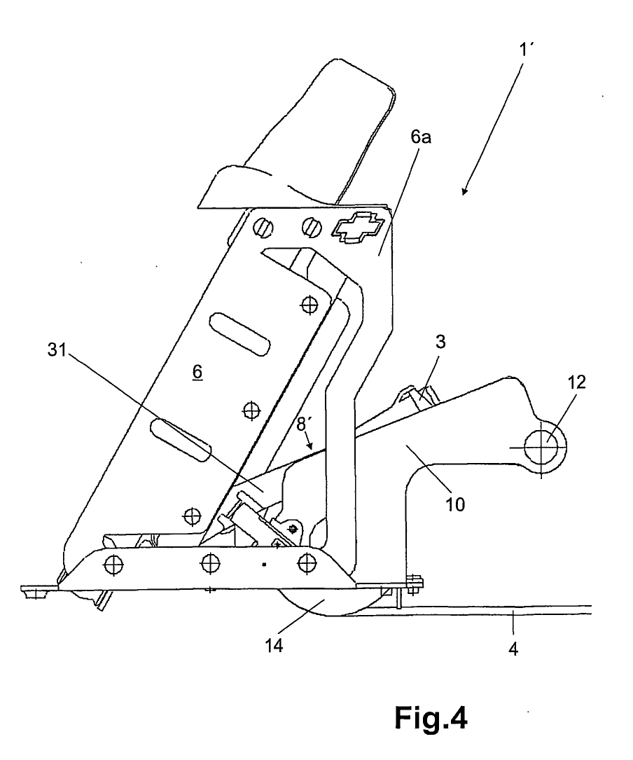

FIG. 4 shows a side view of a further preferred exemplary embodiment of a parking brake according to the invention in an unactuated state.

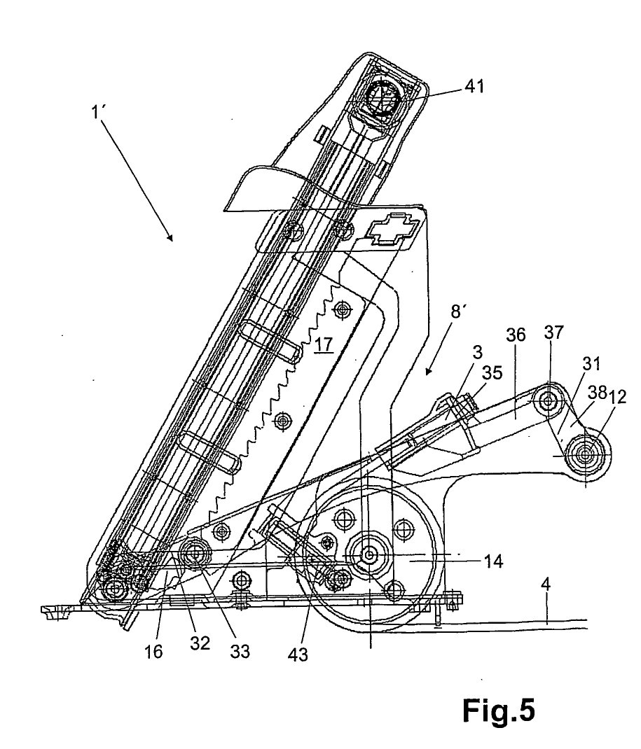

FIG. 5 shows a schematic side view of the parking brake according to FIG. 4 in an unactuated state with parts partially broken away.

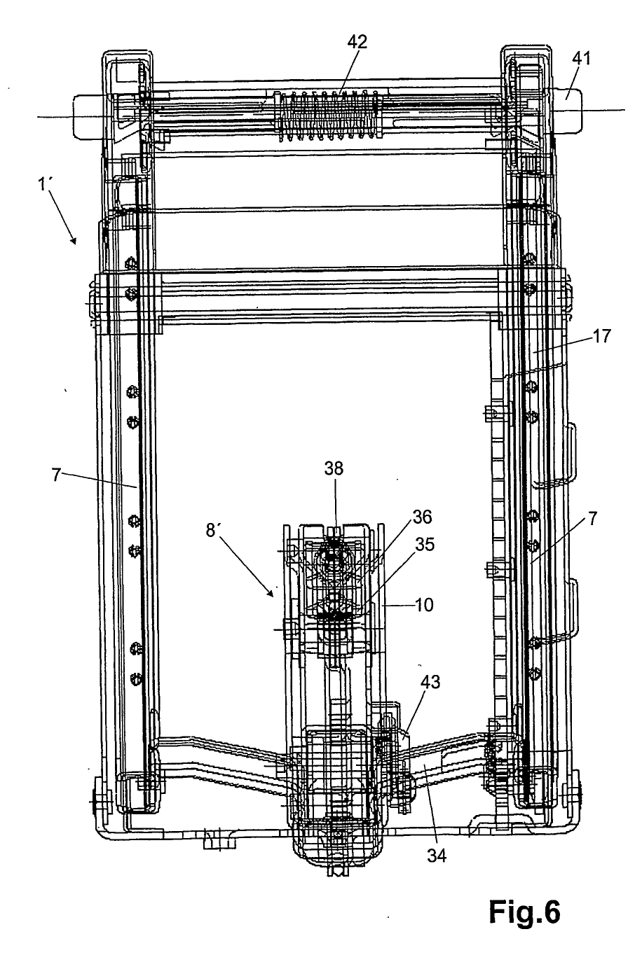

FIG. 6 shows a plan view from above of the parking brake according to FIG. 4 and 5.

The parking brake illustrated in FIG. 1 to 3 is a hand-operated parking brake 1 which, by a hand-grip 2 being pulled, tensions a brake cable 4 fitted to a coupling unit 3. The hand-grip 2 is fastened on two parallel pins 5 which are arranged on the hand-grip 2 and, for the axial displacement in the direction of the pins 5, are guided axially in two tubes 7 which protrude parallel from a holder 6 fixed on the bodywork and which define a longitudinal guide. The upper end of the tube 7 is supported via a vertically protruding support 6a of the holder 6.

The tubes 7 protrude at an angle of approximately 30° with respect to the vertical and 60° with respect to the horizontal counter to the direction of travel of the vehicle, with the result that the hand-grip 2 can be ergonomically and favorably gripped and pulled by the driver's hand. For this purpose, cushioning for the ball of the thumb may be provided.

A conversion unit, which is denoted overall by 8, is connected between the hand-grip 2 and the coupling unit 3 for the brake cable 4 and converts the linear actuation of the hand-grip 2 into a likewise linear pulling movement on the brake cable 4, with, in the present case, in order to reduce the force required for the actuation, the longer travel of the hand-grip 2 bringing about a linearly and proportionally short travel of the brake cable 4 for tightening purposes.

For this purpose, the conversion unit 8 has a further support part 10, which is designed as a sheet-metal part and has a U-shaped cross section, a base 10a of the U being arranged on the holder 2 and the two limbs 10b, 10c of the U being essentially angled upward. The two limbs 10b, 10c furthermore have a projection in which a segment of a cable pulley 11 is mounted in a joint 12 between the two limbs 10b, 10c.

Furthermore, a plate body 13 is mounted in the region of the joint 12 and is fastened to the cable pulley 11 and can be pivoted together with the latter about the articulation 12. For this purpose, rivet connections 13a, 13b are provided between the two parts. Moreover, the plate body has, at a short distance from the articulation 12, an articulation 13c for a coupling unit 3 for the brake cable 4. In order to mount the brake cable 4, which is output approximately at the distance of the cable pulley 11, at a shorter distance from the articulation 12, said brake cable is guided via a deflection pulley 14 which is mounted centrally on an articulation 15 in the frame 2 and which guides peripherally the brake cable 4. The output of the cable is therefore arranged on the plate body 13 in such a manner that when the cable pulley 11 is rotated, the brake cable 14 is also rotated.

A traction cable 15 is fastened on the circumference of the cable pulley 11 and its other end is coupled to the hand-grip 2. In the present exemplary embodiment, the other end of the traction cable 15 is arranged centrally on a transverse strut 2a between the two tubes 7, said transverse strut running parallel to the hand-grip 2. It is therefore advantageously possible to cover the attachment of the traction cable 15.

The force which is to be applied for pulling the hand-grip 2 then first depends on the lever ratios of the radius of the cable pulley 11 and of the brake-cable articulation 13c, which lever ratios are defined by the center distances from the pivot axis. It can be seen that the radius of the cable pulley 11 changes over its circumference and therefore a progressive change in the lever ratios is provided.

A tooth segment 16 is arranged in the region of the circumference of the cable pulley 11, and a catch 17, which is arranged pivotably on the holder 6, is pretensioned by a spring 17a in the direction of the tooth segment 16 and can engage with the latter in a ratchet-type manner and secure the parking brake. The catch 17 can be released counter to the pretensioning of the spring and, if appropriate, a further securing spring, by actuation of a push-button 18 in the region of the hand-grip 2, which push-button is connected to the catch via a release device 19, as a result of which by tensioning the brake cable 3 in the conversion unit the rack 10 and hence the hand-grip 2 are displaced back into a release position. It is possible to integrate a spring in the guide system of the hand-grip, enabling a spring also to be brought back over the last section in which the brake cable 4 is already relieved of load. Furthermore, in order to damp the noises and the movement of the hand-grip, a gas-filled spring system can be integrated in the region of the tubes 7 in order to enable the hand-grip to slide back slowly into the starting position after release of the spring. The brake cable 4 preferably comprises an automatically adjusting control-cable adjustment which adjusts the brake cable in the unloaded state of the parking brake. The release device 19 is flexible and can therefore be pulled out.

A motor-driven power assist of the parking brake is preferably provided, either by hydraulic or pneumatic means in the region of the guide of the hand-grip or by a driven gearwheel, for example, together with the rack.

In the present exemplary embodiment, a power assist unit 18 is provided in order to assist the pulling movement, said unit, in the present case, comprising a mechanical compression spring, but it may also be designed as a gas-filled compression spring, with its one end 18a being fastened to the frame 2 or to the bodywork and its other end 18b being articulated on the cable pulley 11. The power assist unit operates only after a dead-center position has been exceeded in the direction of application of the parking brake 1. The associated spring is tensioned again by the force of the brake cable 4 when the parking brake 1 is released.

The further exemplary embodiment of a parking brake 1′ according to the invention, illustrated in FIG. 4 to 6, has essentially the same components as the parking brake 1 described above, and so, for simplification purposes, the same reference numbers are used if the parts coincide in terms of function, and only the differences will be discussed in detail below.

In contrast to the parking brake 1, the parking brake 1′, illustrated in the FIG. 4 to 6, has the conversion unit 8′ which, as a multi-joint transmission, has a long lever 31 which is mounted in the region of an articulation 12 in the support part 10. Furthermore, the conversion unit 8′ comprises a short link 32 which is coupled to the long link 31 via a joint 33 and which can take up an angle relative to the long link 31. The short link 32 is coupled to a web-like extension 34 of the hand-grip 2, so that pulling of the hand-grip 2 displaces the short link 32 about the joint 33 and the long link 31 about the joint 12. In this case, the short link 32 deviates relative to the long link 31 and compensates for the shortening distance of the extension 34 from the articulation 12.

A coupling unit 3 for the brake cable 4 is inserted in a receptacle 35. The receptacle 35 is mounted via a first lever 36 in the long link 31 at an articulation 37, a further lever 38 protruding rigidly from the first lever 36 and being secured in the articulation 12. This avoids spinning in the articulation 37. The long link 31 thereby carries along the first lever 36, so that the lever ratios are also determined here by the distances of the receptacle 35 from the articulation 12, on the one hand, and the articulation 12 from the extension 34, on the other hand. It has to be understood that a power assist device may also be provided here.

The coupling device 3 accordingly transfers a pulling force to the brake cable 4 in accordance with the changing step-up which is defined by the center ratios of the links and lever.

A catch 17 is likewise arranged pivotably on the extension 34 while an associated tooth segment 16 is provided along one of the two tubes 6, which are of polygonal design in the present case, and secures the locking position, which is set in each case by pulling of the hand-grip 2, by latching together a tooth segment 16 arranged on the frame 6.

The catch 17 is pretensioned by a spring 17a in the direction of the tooth segment 16 and can be released via a plunger rod which is tensioned when a release button 41 arranged in the region of the hand-grip 2 is actuated. The release button 41 can be actuated counter to the pretensioning of a compression spring 42, which is arranged in the hand-grip, in order to unlock the catch 17.

A contact switch for an electric display is denoted by 43.

It is also possible here to provide a motor-driven auxiliary drive either in the region of the guide of the hand-grip 2 or in the region of one of the rotary joints of the conversion device 8′.

The two parking brakes 1 and 1′ advantageously enable the installation of a compact brake unit in the interior of a motor vehicle, so that the intermediate space in front of or behind the hand-grip 2 may optionally be provided for the arrangement of armrests, cup-holders or the like.

The invention has been explained above with reference to certain center distances of the joints or of the gear wheels. It has to be understood that the invention also makes it possible to arrange the center spacings in a different manner so as to set a certain step-up ratio, and it furthermore has to be understood that a further intermediate lever may also be provided in order to achieve a more favorable step-up. Finally, the elements which have been described from the two exemplary embodiments may also be combined in order to achieve a parking brake according to the invention.

The invention has been explained in greater detail above by way of example using a hand-operated parking brake 1 or 1′. It has to be understood that the parking brake according to the invention may also be designed as a foot-operated parking brake with a pedal, the hand-grip 2 then being provided as a pedal on which a pressure is exerted rather than a pull. The release button for releasing the locking catch may then also be provided at a different location than for the actuation by hand.

1-34. (canceled).

35. A parking brake for a vehicle, comprising:
a holder;
a grip displaceable relative to said holder;
a guide including two parallel tubes, each of said tubes guiding a pin in an axial direction of the tubes, said grip being arranged at a respective first end of each of the pins and oriented axially with respect to said pins, said grip being displaceable axially away from the holder to a locking position;
a brake cable;
a coupling unit for tensioning said brake cable during a displacement of said grip;
a locking device for holding said grip in the locking position;
a support part;
a conversion unit coupled to said holder for converting an axial displacement of said grip into a tensioning of said brake cable, said conversion unit including a multijoint transmission having a long link and a short link, said long link being mounted pivotably on said support part and coupled to said grip via said short link, said short link being connected pivotably to said long link, wherein said short link and said long link bend with respect to each other so as to compensate for the displacement of said grip; and
an extension disposed at the grip and arranged parallel to a displacement direction of the grip, the extension coupled pivotably to the short link.

36. The parking brake as claimed in claim 35, wherein said extension is connected rigidly to said grip.

37. The parking brake as claimed in claim 35, wherein said locking device is disposed outside said guide in a region of said conversion unit.

38. The parking brake as claimed in claim 35, wherein said long link is mounted pivotably on an articulation of said support part.

39. The parking brake as claimed in claim 35, further providing a lever coupled to said long link, and wherein said coupling unit engages on said lever.

40. The parking brake as claimed in claim 35, wherein said short link and said long link are disposed at an angle to each other so as to enable an upward buckling of the short link and the long link.

41. The parking brake as claimed in claim 35, wherein the conversion unit includes a deflection roller having a periphery, said brake cable being guided via the periphery to said coupling unit.

42. The parking brake as claimed in claim 35, wherein at least one of said tubes includes a slot and a corresponding pin includes an articulated section protruding through the slot and engaging said conversion unit.

43. The parking brake as claimed in claim 35, wherein said guide includes a damping device for damping a return movement of said grip from the locking position to a starting position after release of said locking device.

44. The parking brake as claimed in claim 35, wherein said locking device includes a catch engaging in a tooth segment and a catch spring for pretensioning said catch in a direction of said tooth segment.

45. The parking brake as claimed in claim 35, further comprising a release device for releasing said locking device.

46. The parking brake as claimed in claim 35, wherein the conversion unit provides a step-up of said grip relative to said brake cable by a factor of between three and fifteen.

47. The parking brake as claimed in claim 35, wherein said grip is a hand-grip for a hand-operated parking brake.

48. A parking brake for a vehicle, comprising
a holder;
a grip displaceable relative to said holder;
a guide including two parallel tubes each of said tubes guiding a respective pin along an axis of the tube, said grip being disposed at a respective first end of each of the pins and being oriented axially with respect to the pins, the grip being axially displaceable away from the holder to a locking position;
a cable pulley;
a brake cable;
a coupling unit disposed at said cable pulley for tensioning said brake cable during a displacement of said grip;
a locking device for holding said grip in the locking position;
a conversion unit coupled to said holder for converting the axial displacement of said grip into a tensioning of said brake cable; and
a traction cable for coupling said grip with said conversion unit, said traction cable being guided by said cable pulley.

49. The parking brake as claimed in claim 48, wherein said conversion unit is mounted at a support part, said support part being fastened to said holder.

50. The parking brake as claimed in claim 49, wherein said support part includes an articulation, at least a section of said cable pulley being mounted on the articulation.

51. The parking brake as claimed in claim 49, wherein said support part has a U-shaped cross section with two upwardly projecting limbs, and wherein said cable pulley is mounted between the two limbs.

52. The parking brake as claimed in claim 50, further comprising a link mounted on said cable pulley at a region outside said articulation, said link bearing against said support part at an end facing away from said articulation and including an angled limb coupled with said brake cable.

53. The parking brake as claimed in claim 50, wherein a distance between said coupling unit and said articulation is smaller than a radius of said cable pulley.

54. The parking brake as claimed in claim 50, further comprising a power assist device including a first end engaging on said pulley at a region outside said articulation.

55. The parking brake as claimed in claim 48, wherein said traction cable is fastened to said cable pulley.

56. The parking brake as claimed in claim 48, wherein said coupling unit is pivotably mounted at an articulation on said cable pulley at a fixed distance.

57. The parking brake as claimed in claim 48, further comprising a plate body coupled to the cable pulley and wherein said coupling unit is arranged at said plate body.

58. The parking brake as claimed in claim 48, further comprising a strut arranged parallel to said grip and wherein said traction cable is arranged on said strut.

59. The parking brake as claimed in claim 48, wherein said conversion unit includes a deflection roller wherein said brake cable is guided via a periphery of said deflection roller to said coupling unit.

60. The parking brake as claimed in claim 48, at least one of said tubes includes a slot and a pin corresponding to the at least one tube includes an articulated section protruding through the slot and engaging said conversion unit.

61. The parking brake as claimed in claim 48, wherein said guide includes a damping device for damping a return movement of said grip from the locking position to a starting position after release of said locking device.

62. The parking brake as claimed in claim 48, wherein said locking device includes a catch engaging in a tooth segment and a catch spring for pretensioning said catch in a direction of said tooth segment.

63. The parking brake as claimed in claim 48, further comprising a release device for releasing said locking device.

64. The parking brake as claimed in claim 48, wherein the conversion unit provides a step-up of said grip relative to said brake cable by a factor of between three and fifteen.

65. The parking brake as claimed in claim 48, wherein said grip is a hand-grip for a hand-operated parking brake.
